(19) United States
(12) Patent Application Publication
(10) Pub. No.: US 2018/0001768 A1
(43) Pub. Date: Jan. 4, 2018

(54) HEAD-UP DISPLAY APPARATUS

(71) Applicant: CALSONIC KANSEI CORPORATION, Saitama (JP)

(72) Inventor: Toshifumi TAKITA, Saitama-shi, Saitama (JP)

(21) Appl. No.: 15/544,832

(22) PCT Filed: Sep. 4, 2015
(86) PCT No.: PCT/JP2015/075197

§ 371 Date: Jul. 19, 2017

(30) Foreign Application Priority Data
Jan. 20, 2015 (JP) 2015-008298

(51) Int. Cl. B60K 35/00; G02B 27/01

(52) U.S. Cl. CPC B60K 35/00; G02B 27/0103; G02B 2027/0109; G02B 2027/0105

(57) ABSTRACT

The head-up display apparatus includes a displaying device installed inside an instrument panel, an opening portion formed in the instrument panel, and a combiner disposed above the opening portion. An image of the displaying device is projected to the combiner through the opening portion. The displaying device is a segment display. The segment display includes a plurality of light sources and a character/symbol plate having a plurality of image informing parts. The combiner is made of a non-translucent dark plate or a semi-translucent dark smoke plate.

### TECHNICAL FIELD

This disclosure relates to a head-up display apparatus.

### BACKGROUND ART

There is known a head-up display apparatus that is mounted on a vehicle such as a car (See. Patent Literature 1, for example). Such a head-up display is configured to project an image of a displaying device forward. For example, a conventional head-up display apparatus includes a displaying device installed inside an instrument panel, an opening portion formed in the instrument panel, and a combiner disposed above the combiner. In the apparatus, an image of the displaying device is projected to the combiner through the opening portion.

The above head-up display apparatus is capable of directly showing information within eyesight of the driver. Accordingly, the driver can obtain the information with little movement of the line of sight and/or with little adjustment of the focus of the eyes.

In some of the conventional head-up display apparatuses, the combiner is made of a transparent plate, and an enhanced reflection film such as an expensive half mirror and multilayered dielectrics is applied to a reflection surface of the transparent combiner to have a surface reflectivity about 30 to 60% (i.e., to make the combiner translucency).

Further, in the Patent Literature 1, the displaying device is configured to have a segment display, in which various types of images are formed by turning on and off a plurality of image forming parts.

### CITATION LIST

### Patent Literature

Patent Literature 1: JP 3,144,033 U

### SUMMARY

### Technical Problem

However, as described in the Patent Literature 1, when a displaying device of a head-up display apparatus is a segment display and the combiner is made of a transparent plate, a double image may appear on the combiner. Such a double image is generated when the reflected image on the front surface of the combiner is overlapped with the reflected image on the back surface of the combiner with the positions deviated from each other. Therefore, it is required to apply surface treatment on the combiner to prevent the double images and it increases the costs. Additionally, with the segment display, a turned-off segment may look like to be on.

Accordingly, a main object of this disclosure is to solve the above problem.

### Solution to Problem

In order to solve the above problem, a head-up display apparatus according to this disclosure includes a displaying device that is installed inside an instrument panel, an opening portion that is formed in the instrument panel, and a combiner that is disposed above the opening portion. An image of the displaying device is projected to the combiner through the opening portion. The displaying device comprises a segment display. The segment display is capable of forming a plurality of the images by turning ON and OFF a plurality of image forming parts. The segment display includes a plurality of light sources and a character/symbol plate. The character/symbol plate including the plurality of image forming parts, and the image forming parts are configured such that light emitted from the plurality of the light sources pass through the plurality of image forming parts. The combiner is made of a non-translucent dark plate or a semi-translucent dark smoke plate.

### Advantageous Effects

With the above configuration, the present disclosure is capable of suppressing the generation of double images.

### BRIEF DESCRIPTION OF DRAWINGS

FIG. 1 is a view illustrating a front part of a vehicle cabin having an installation structure for a head-up display apparatus according to an embodiment of this disclosure.

FIG. 2 is a longitudinal section view of the front part of the vehicle cabin illustrated in FIG. 1.

FIG. 3 is an enlarged view of the head-up display apparatus of FIG. 1.

FIG. 4 is a disassembled oblique view of the head-up display apparatus of FIG. 1.

FIG. 5 is a longitudinal section view of the head-up display apparatus of FIG. 1.

FIG. 6 is a front view of a combiner representing an image of the head-up display apparatus of FIG. 1.

FIG. 7 is a front view of a colorless transparent combiner.

### DESCRIPTION OF EMBODIMENTS

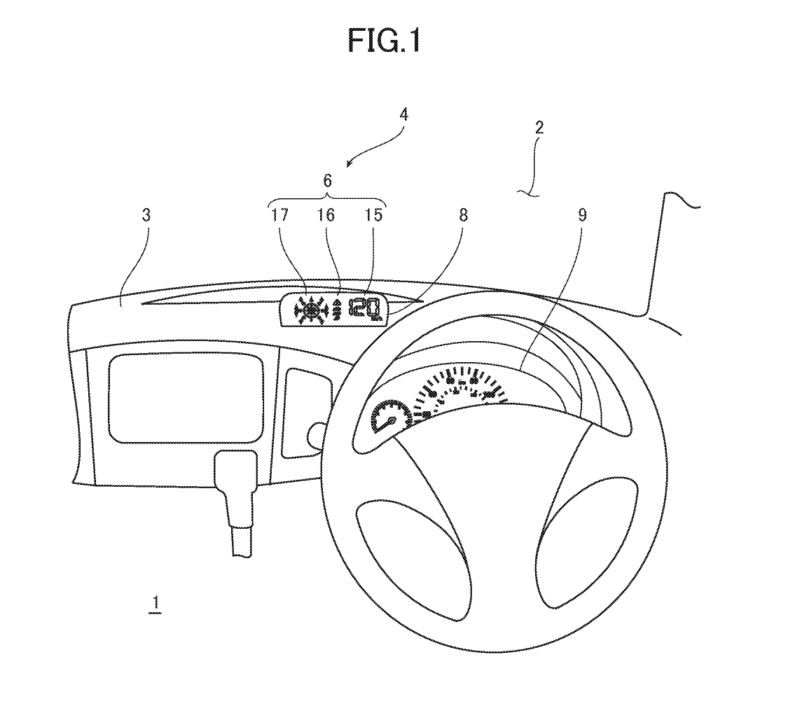

Hereinafter, an embodiment of this disclosure is described with reference to the drawings. FIGS. 1 to 7 are provided to explain the embodiment. It should be noted that in this description, a front-and-rear direction represents a vehicle longitudinal direction and a left-and-right direction represents a vehicle width direction. Further, a near side means a near side from a passenger facing the front side of the vehicle, and a far side means a far side from the passenger facing the front side.

### Embodiment

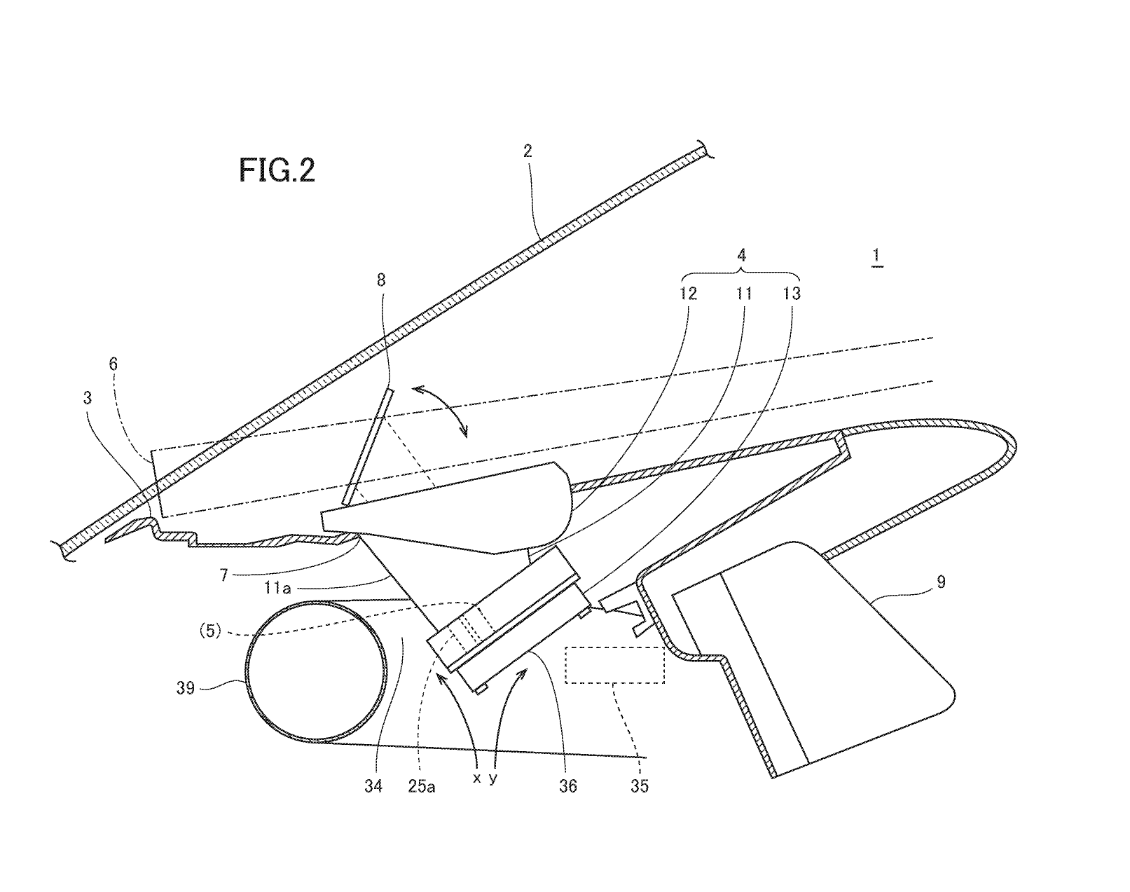

Hereinafter, configurations of the embodiment are described. As illustrated in the schematic view of FIG. 1 and in the section view of FIG. 2, a vehicle such as a car has a windshield glass 2 installed at the front part of the vehicle cabin 1, and an instrument panel 3 is provided under the windshield glass 2.

A head-up display apparatus 4 is then installed in the vehicle. The head-up display apparatus 4 is configured to project an image 6 of the displaying device 5 (illustrated in FIG. 2) forward.

In the embodiment, the head-up display apparatus 4 is installed inside the instrument panel 3. The displaying device 5 is provided inside the head-up display apparatus 4, and information (i.e., image 6) provided by the displaying device 5 is projected to a combiner 8 through an opening portion 7 (illustrated in FIG. 2). Here, the opening portion 7 is formed in the instrument panel 3, and the combiner 8 is disposed above the opening portion 7.

At a part of the instrument panel 3 on the driver's seat side, a meter unit 9 such as measuring instruments, a steering wheel, and the like are provided. Note that although the illustrated example shows a right-hand drive vehicle, this embodiment is also applicable to a left-hand drive vehicle.

As described above, the head-up display apparatus 4 shows required information within the eyesight of the driver, specifically, at a position higher than that of the meter unit 9. The displaying device 5 is a device to provide and display the information, and is realized by, for example, a display panel capable of displaying images (e.g., liquid crystal panel, organic EL panel). The detailed configuration of the displaying device 5 will be described later. The opening portion 7 is formed so as to pass through the image 6 of the displaying device 5. That is, the opening portion 7 is formed at a part of the instrument panel 3 on the front passenger side and above the installation position of the head-up display apparatus 4.

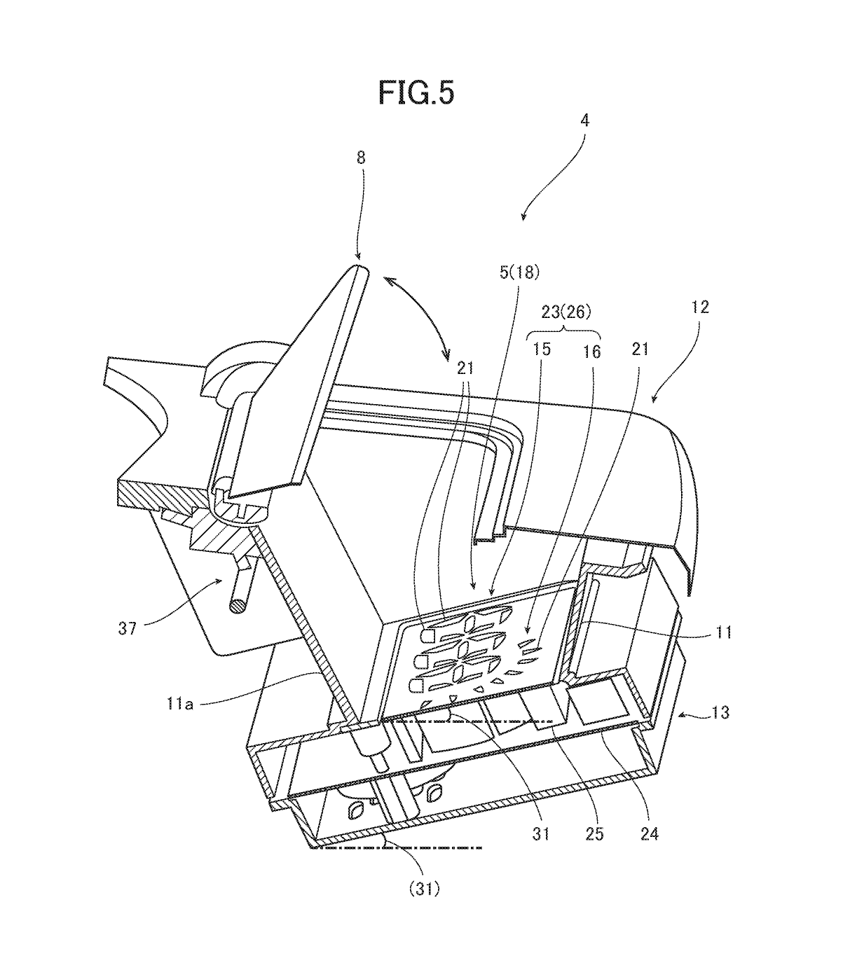

The combiner 8 is a reflection plate to project the image 6 of the displaying device 5. The combiner 8 forms, as a virtual image, the image 6 of the displaying device 5 in front of the combiner 8 at a position away from the combiner 8 by a distance corresponding to the distance between the combiner 8 and the displaying device 5 (see FIG. 2). Here, the angle of the combiner 8 is set to be the intermediate angle between a screen of the displaying device 5, which is arranged almost horizontally (see FIG. 5), and the formed image 6, which is projected in front of the combiner 8 almost vertically. Here, the image 6 of the displaying device 5 is projected to the combiner 8 in a state that the image 6 is inverted in the front-and-rear direction.

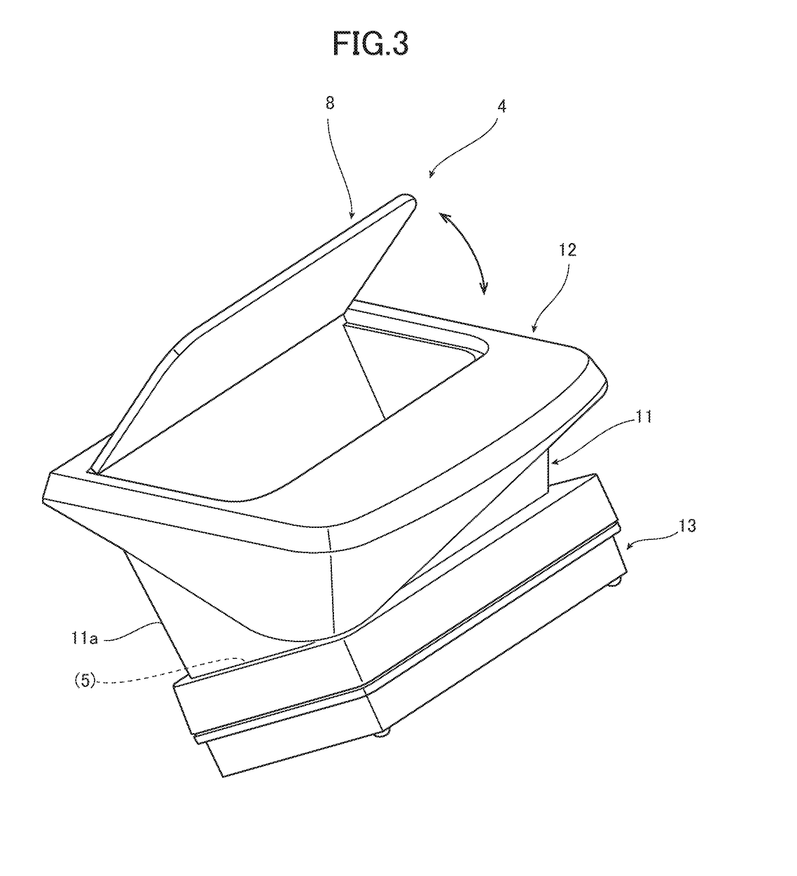

The head-up display apparatus 4 is configured as illustrated in FIGS. 3 to 5. Specifically, the head-up display apparatus 4 is formed mainly by a casing 11, a finisher 12, the combiner 8, and a cover member 13. The casing 11 accommodates the displaying device 5 therein. The finisher 12 has a frame-like shape and is disposed at a top portion of an opening of the casing 11. The combiner 8 is openably disposed on the finisher 12. The cover member 13 is then attached to a lowest portion of the opening of the casing 11. The head-up display apparatus 4 is placed inside the instrument panel 3 to be inclined forward with an angle 31. By placing the head-up display apparatus 4 to be inclined forward, an air flow (see arrows x and y in FIG. 2) flowing upward from the lower side may be generated inside the instrument panel 3. It is thereby expected to dissipate the heat generated by light sources 22 of the head-up display apparatus 4. Further, inside the instrument panel 3, an air conditioning duct 39 and an electronic unit 35 are respectively disposed in the front and rear spaces of the head-up display apparatus 4.

The displaying device 5 is arranged on the bottom part of the casing 11 so as to face upward. That is, the image 6 is directly projected to the combiner 8 through the straight optical passage extending upward. Accordingly, it is possible to miniaturize and simplify the casing 11 by shortening the optical passage in the casing 11. The casing 11 has substantially an oblong square cylindrical shape in the plan view. To be specific, the casing 11 has a front sidewall 11a, a rear sidewall, a left sidewall, and a right sidewall. The casing 11 does not have a reflection part or an optical-passage refraction part inside thereof to change the direction of the optical passage. Further, the casing 11 does not have an enlarging optical system inside thereof and forms the image 6 of the displaying device 5 without magnification.

There are several types of combiners. For example, a part of the windshield glass 2 may be used as the combiner 8. That is, the windshield glass 2 may be provided with a black printed part as the combiner 8 or the windshield glass 2 may have a reflection film attached thereto as the combiner 8, such that the image 6 is projected to the combiner 8. In such cases, the combiner 8 is made of a plate-like resin or a plate-like glass having high heat resistance, and is provided separately from the windshield glass 2. In general, a combiner has an enhanced reflection film such as an expensive half mirror and multilayered dielectrics are applied to the reflection surface of the combiner so as to have a surface reflectivity of about 30 to 60%. However, in this embodiment, the combiner 8 of this embodiment is not applied with an enhanced reflection film, and therefore the surface reflectivity is kept low (for example, reflectivity is about 7%). The combiner 8 opens and is closed by an opening/closing driving device 37 installed inside the casing 11.

When the head-up display apparatus 4 is inserted to the opening portion 7 of the instrument panel 3, the finisher 12 covers the edges of the opening portion 7. That is, the finisher 12 is designed to be larger than the opening portion 7. Further, the finisher 12 has a fitting part, which has a three-dimensional shape, on the lower surface or the lower edge portion to be fixed with the curved shape of the instrument panel 3.

The cover member 13 is provided separately from the casing 11 but disposed to form the bottom wall of the casing 11. In this case, the cover member 13 forms a displaying unit integrally including the parts of the displaying device 5, such as a character/symbol plate 23, a circuit board 24, and a light-housing 25. The cover member 13 is then attached to the casing 11. Note that the cover member 13 may be integrally provided with the casing 11, where applicable.

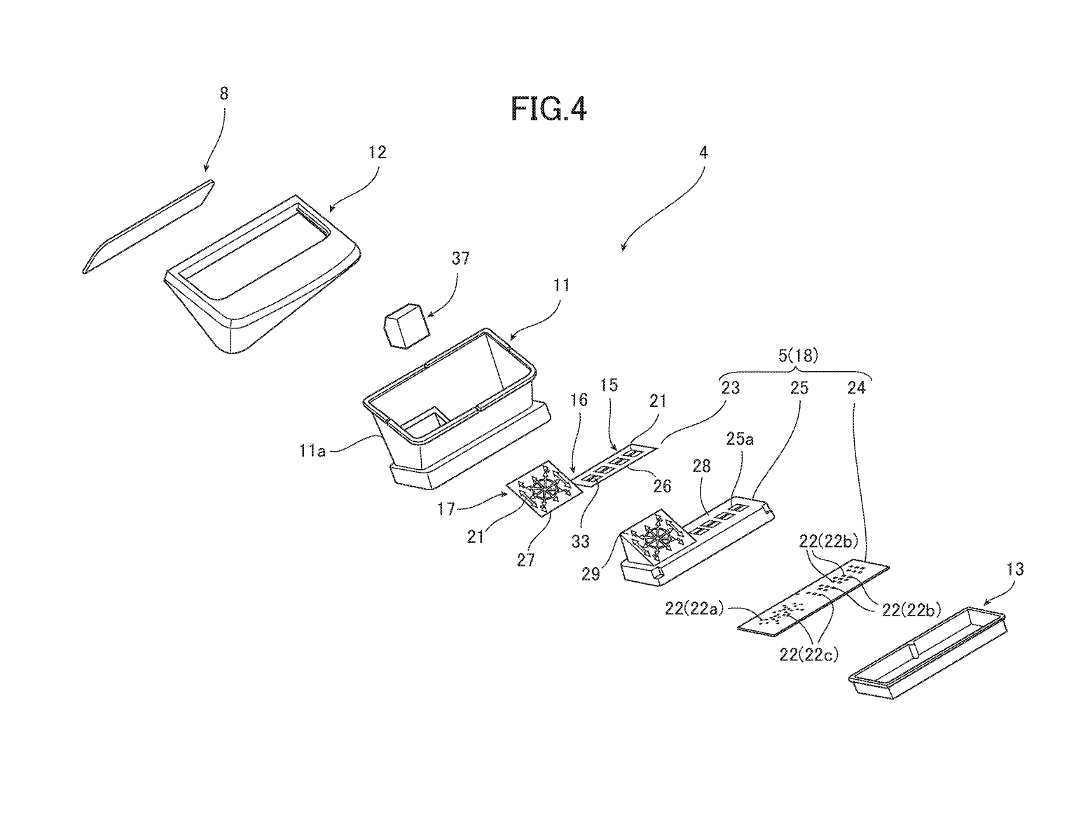

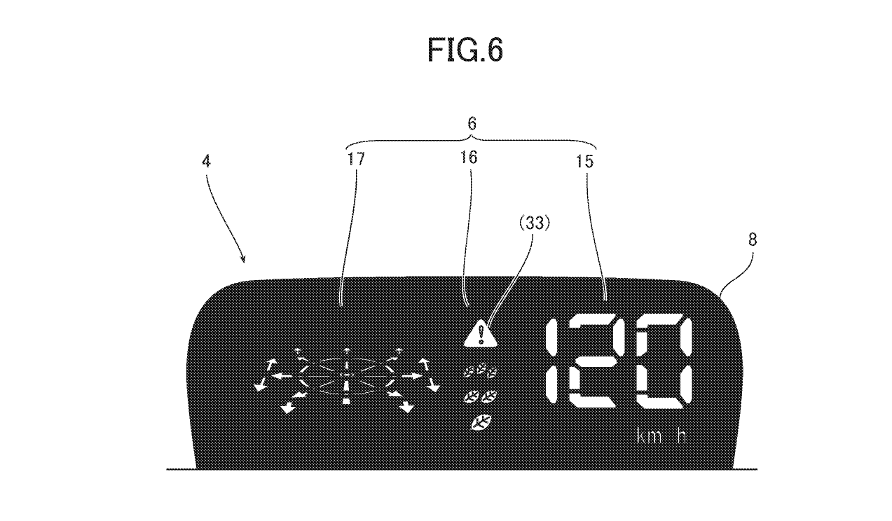

In addition to the above configurations, the head-up display apparatus 4 of the embodiment further includes the following configuration. (1) As illustrated in FIGS. 4 and 5, the displaying device 5 is a segment display 18 in which various types of images 6 (see examples illustrated in FIG. 6) are formed by turning on and off a plurality of image forming parts 21. The segment display 18 includes a plurality of light sources 22 (see FIG. 4) and the character/symbol plate 23. The character/symbol plate 23 includes the plurality of image forming parts 21, and the lights emitted from the plurality of light sources 22 pass through the plurality of image forming parts 21. Further, as illustrated in FIG. 6, the combiner 8 is configured by a non-translucent dark (black color) plate or by a dark (black-color based) semi-translucent smoke plate.

As illustrated in FIG. 6, the displaying device 5 includes, for example, a meter displaying part 15, a scale displaying part 16, and a route displaying part 17. The meter displaying part 15 shows a vehicle speed, an engine speed, and the like by numbers. The scale displaying part 16 shows a fuel remaining amount, a distance to the destination, and the like by scales, etc. The route displaying part 17 shows a traveling route by arrows, etc. In this embodiment, the displaying device 5 is not a display panel that can display the above information by an image. Instead, the displaying device 5 of this embodiment is a segment display 18 (see FIGS. 4 and 5). Here, some segment displays (or some displaying devices having a similar configuration) may include a fluorescent tube, a segment-type liquid crystal panel, a passive matrix type liquid crystal panel, or the like. However, the displaying device 5 of this embodiment is configured by using the segment display 18 and the character/symbol plate 23 including the plurality of the light sources 22 (see FIG. 4) and the plurality of image forming parts 21. With this, the displaying device 5 can achieve high brightness at a low cost.

The image forming parts 21 are light transmitting parts or segments provided on the character/symbol plate 23 so as to form various types of images 6. In accordance with the contents of the images 6, the image forming parts 21 may be individually or entirely configured as colorless transparent parts or as colored transparent parts.

For example, in a case of the meter displaying part 15, the corresponding image forming part 21 may be a segment display. The segment display includes seven segments arranged to form a number “8”. In a case of the scale displaying part 16, the corresponding image forming part 21 is configured by arranging a plurality of segments in a form of bar graph. For example, with the image exemplary shown in FIG. 6, a plurality of segments each having a leaf-like shape are arranged to indicate a state and degree of eco-driving. In a case of the route displaying part 17, the corresponding image forming part 21 is configured by appropriately arranging segments having a dot shape, a bar shape, an arrow shape, or the like so as to express various types of traveling routes. In this embodiment, the route displaying part 17 at least includes a center dot (first layer image), eight lines (second layer image) arranged around the center dot, and one line and seven arrows (third layer image) arranged around the eight lines. That is, the route displaying part 17 is formed as a three-layered structure. Here, the center dot of the first layer image indicates an intersection. The eight lines of the second layer image indicate the roads existing at the front, rear, right, left, and respective oblique directions with respect to the intersection. The one line of the third layer image indicates a position of the subject vehicle, and the seven arrows of the third layer image indicate directions of the subject vehicle. The image forming parts 21 may further include, for example, a notation with Chinese characters and/or alphabets (for example, km/h).

The light sources 22 are configured to individually illuminate the plurality of the image forming parts 21. The light sources 22 include, for example, LEDs, and the LEDs are disposed on the circuit board 24.

The character/symbol plate 23 is formed by, for example, applying a non-translucent printed layer to a transparent resin plate except for parts for the image forming parts 21.

The displaying device 5 includes a plurality of displaying surfaces (i.e., the character/symbol plates 23) facing different directions from each other. In this embodiment, the displaying device 5 is divided into a first character/symbol plate 26 and a second character/symbol plate 27, as illustrated in FIG. 4. The first character/symbol plate 26 is set as a reference surface and projects the corresponding image upward. The second character/symbol plate 27 is inclined with respect to the reference surface and projects a three-dimensional image which is inclined with respect to the image 6 projected by the first character/symbol plate 26. Note that the upwardly projected image 6 may face in the front-and-rear direction or in the left-and-right direction. However, the upwardly projected image 6 does not have to be vertical (or to be perpendicular to the reference surface). The upwardly projected image 6 may be slightly inclined forward or backward with respect to the vertical direction unless it becomes difficult to recognize the images.

In this embodiment, the first character/symbol plate 26 (i.e., reference surface) includes the meter displaying part 15 and the scale displaying part 16. The second character/symbol plate 27 (i.e., inclined surface) includes the route displaying part 17. Though, the contents of the image 6 projected by the first character/symbol plate 26 and the second character/symbol plate 27 should not be limited to the above example. For example, although the first character/symbol plate 26 is disposed on the right side and the second character/symbol plate 27 is disposed on the left side on the drawings, their positions may be switched alternatively.

By including the plurality of displaying surfaces each facing different directions, the meter displaying part 15 and the scale displaying part 16 are vertically projected to the combiner 8 while the route displaying part 17 is inclined and projected to the combiner 8. Accordingly, the driver can feel a sense of depth and a stereoscopic effect with the image 6 of the route displaying part 17 in a similar way as the driver sees the actual road and the like. Therefore, the driver can easily recognize the traveling routes and/or the distances. Accordingly, the route displaying part 17 on the combiner 8 can give the driver a different visual effect from what the meter displaying part 15 or the scale displaying part 16 does. In other words, the apparatus can diversify the images of the displaying device 5. Further, the route displaying part 17 on the displaying device 5, which has an inclined surface, is disposed next to the meter displaying part 15 and scale displaying part 16 on the displaying device 5, which are directed to face vertically. With the contrast effect of them, the route displaying part 17 projected on the combiner 8 can further improve a sense of depth and the stereoscopic effect. As a result, it is possible to enhance the commercial value of the head-up display apparatus 4.

A position of the rear edge of the second character/symbol plate 27 is substantially identical to a position of the rear edge of the first character/symbol plate 26 in a side view, while a position of the front edge of the second character/symbol plate 27 is higher than a position of the front edge of the first character/symbol plate 26 in the side view. Additionally, the shape of the traveling route image projected to the combiner 8 is modified such that the near side of the image is narrower than the far side thereof. As a result, the image can give a distance feeling. Further, as described above, the distance from the first character/symbol plate 26 to the combiner 8 is different from the distance from the second character/symbol plate 27 to the combiner 8. Therefore, the image 6 of the first character/symbol plate 26 (e.g., meter displaying part 15 and scale displaying part 16 projected to combiner 8) is projected to far side compared to the image 6 of the second character/symbol plate 27 (e.g., route displaying part 17). In other words, the driver can have a distance feeling and a sense of depth.

Note that when the second character/symbol plate 27 is excessively inclined with respect to the first character/symbol plate 26, each of the corresponding images 6 may interfere with each other and therefore the driver may not be able to see a part of the images. Therefore, the inclined angle of the second character/symbol plate 27 with respect to the first character/symbol plate 26 (or with respect to a virtual surface) is preferably set to, for example, about 30°±15° to minimize the interfered portion.

Further, when the route displaying part 17 is projected to the combiner 8, the brightness of the light sources 22 corresponding to the near side of the traveling route is set higher than that of the light sources 22 corresponding to the far side. Accordingly, the route displaying part 17 can give a stereoscopic effect and a distance sense to the driver with the brightness difference. As described above, the image 6 of the displaying device 5 is projected to the combiner 8 in the state that the image 6 is inverted in the front-and-rear direction. Hence, the near side of the traveling route in the displaying device 5 is positioned the far side, and the far side of the traveling route in the displaying device 5 is positioned at the near side. Further, the brightness difference may be achieved by using different light sources 22 such as a high-brightness light source 22a and a low-brightness light source. Alternatively, the brightness difference may be achieved by modifying the brightness of each of the light sources 22, which are identical to each other. Further alternatively, the brightness difference may be achieved by the combination thereof.

Further, the shape of the route displaying part 17 on the second character/symbol plate 27 is modified such that the near side of the image is thicker than the far side thereof. By having such a difference in thickness and by using the perspective effect, it is possible to further give a stereoscopic effect and a sense of the depth to the driver. Here, it is preferable to determine the degree of the difference in thickness in accordance with the inclination of the route displaying part 17 such that it can realize a more natural perspective feeling.

As the second character/symbol plate 27 is inclined and is projected to the combiner 8, the route displaying part 17 projected by the second character/symbol plate 27 gives magnificently different visual effects and stereoscopic effects from the route displaying part 17 projected to the combiner 8 vertically. It is possible to project the route displaying part 17 to the combiner 8 only with the modified shape of the route displaying part 17 on the second character/symbol plate 27 (i.e., but without inclining the route displaying part 17 projected to the combiner 8). However, it is preferable and more effective to use the modified shape of the route displaying part 17 for the route displaying part 17 projected to the combiner 8 with such an inclination.

The circuit board 24 installed with the light sources 22 is configured with a single board. The circuit board 24 is arranged to be parallel with the first character/symbol plate 26 and with the cover member 13.

Alternatively, the character/symbol plate 23 and the circuit board 24 may be divided into three or more plates and oriented to different directions from each other.

The combiner 8 includes block color. Here, a dark plate means a plate having light transmittance of 0% or close to 0%. Further, a dark smoke plate is not a colorless transparent plate.

(2) As illustrated in FIG. 4, the light-housing 25 is disposed between the light sources 22 and the character/symbol plate 23. The light-housing 25 guides the light emitted from each of the light sources 22 to each of the corresponding image forming parts 21.

The light-housing 25 is disposed between the circuit board 24 and the character/symbol plate 23 so as to be in close contact with the upper surface of the circuit board 24 and the bottom surface of the character/symbol plate 23 without a gap. In the light-housing 25, a plurality of light-guiding holes 25a is formed. The light-guiding holes 25a are individually provided for each of the light sources 22. The light-housing 25 is made of, for example, a white resin having a smooth surface with high reflectivity. The image forming parts 21 are arranged at positions which coincide with the positions of the light-guiding holes 25a.

Here, when the character/symbol plate 23 is divided into the first character/symbol plate 26 and the second character/symbol plate 27 (or divided into more plates), the top surface of the light-housing 25 is also divided accordingly to have separate abutting surfaces 28, 29 for each of the first character/symbol plate 26 and the second character/symbol plate 27.

(3) The light sources 22 include white LEDs 22b.

For example, the white LEDs 22b may be configured to emit blue light through a yellow phosphor and synthesize the blue light, which is not converted by the phosphor, and yellow light, which is obtained by converting the blue light by the yellow phosphor, to generate the white light. However, the white LEDs 22b should not be limited to the above. In this embodiment, the white LEDs 22b are used for the meter displaying part 15 on the first character/symbol plate 26. Here, for the parts corresponding to the white LEDs 22b, it is preferable to have the image forming parts 21 of the character/symbol plate 23 be colorless and transparent.

(4) The light sources 22 include RGB full-color LEDs 22c.

The RGB full-color LEDs 22c are configured by combining the three kinds of LEDs (i.e., red LED, green LED, and blue LED) to achieve full color light. In this embodiment, the RGB full-color LEDs 22c are used at least for the scale displaying part 16 on the first character/symbol plate 26 and the route displaying part 17 on the second character/symbol plate 27. Here, for the parts corresponding to the RGB full-color LEDs 22c, it is preferable to have the image forming parts 21 of the character/symbol plate 23 be colorless and transparent.

Note that the white LEDs 22b and the RGB full-color LEDs 22c may be mixedly arranged on the circuit board 24 depending on the types and contents of the image 6.

With this embodiment, the following operations and effects are achieved.

The head-up display apparatus 4 of this embodiment is configured to project the image 6 of the displaying device 5 to the combiner 8 through the opening portion 7 so as to form a virtual image in front of the combiner 8. The driver and the passengers can visually recognize the image 6. Here, the opening portion 7 is formed inside the instrument panel 3, and the combiner 8 is disposed above the opening portion 7. As described above, the head-up display apparatus 4 is capable of showing the information within the eyesight of the driver such that the driver can obtain the information with little movement of the line of sight and/or with little adjustment of the focus of the eyes.

(1) The head-up display apparatus 4 is configured by the displaying device 5 (i.e., the segment display 18) and the combiner 8 having the dark plate or the dark smoke plate. With this configuration, the image 6 generated by the segment display 18 has high brightness and a distinct contour. On the other hand, the background, which is realized by the combiner 8 (i.e., dark plate or dark smoke plate), has low brightness. That is, the brightness difference or the contrast between the image 6 and the background becomes relatively large. As a result, the image 6 shown by the head-up display apparatus 4 becomes easy to see regardless of the other conditions such as brightness in the outside of the vehicle or the sunlight.

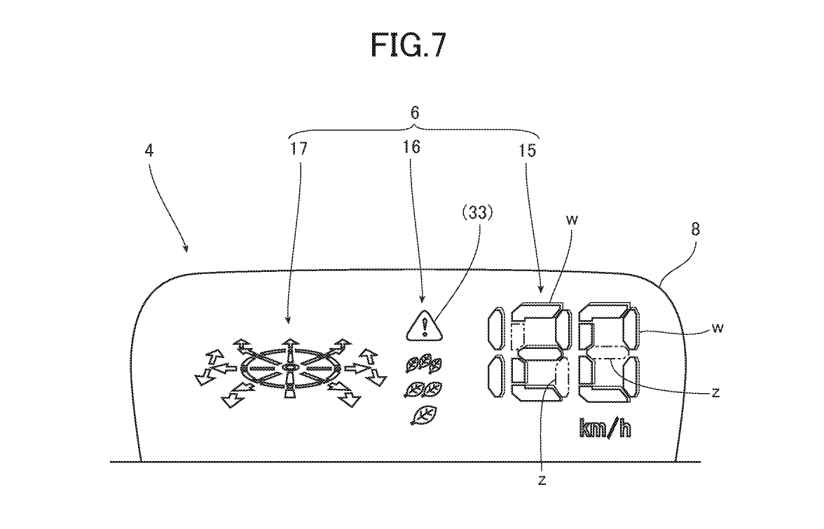

Further, the combiner 8 is made of a non-translucent dark plate or semi-translucent dark smoke plate. Accordingly, reflection of the image 6 on the back surface of the combiner 8 is prevented. When the combiner 8 is made of a colorless and transparent plate (see FIG. 7, for example), the reflection of the image 6 on the front surface of the combiner 8 is overlapped with the reflection of the image 6 on the back surface of the combiner 8 with the positions deviated from each other. That is, a double image w may appear on the combiner 8 (see meter displaying part 15 in FIG. 7). However, by utilizing the combiner 8 made of the dark plate or the dark smoke plate, the reflection of the image 6 on the black surface is reduced. As a result, it becomes unnecessary to apply surface treatment for suppressing the double image w to the combiner 8, and thereby reducing the manufacturing costs.

The segment display 18 further includes a plurality of light sources 22, and the character/symbol plate 23 having a plurality of image forming parts 21. With this, the segment display 18 becomes much less expensive compared to, for example, a liquid crystal panel. Further, the segment display 18 of this disclosure is even less expensive compared to other segment displays such as a fluorescent-type segment display, a segment-type liquid crystal panel, a passive matrix type liquid crystal panel. Additionally, the segment display 18 of this disclosure can achieve high brightness light sources 22 without increasing the manufacturing costs. As a result, the manufacturing costs for the head-up display apparatus 4 can be magnificently reduced, while the image 6 is clearly projected. This may spread the head-up display apparatus 4 to various types of vehicles at reasonable prices. Note that since the information displayed by the head-up display apparatus 4 is limited, the displaying device 5 should be able to provide enough information to the driver even if the displaying device 5 is made of the segment display 18.

When the segment display 18 includes the character/symbol plate 23 having a translucent image forming part 21, the wall surfaces of the light-guiding holes 25a of the white light-housing 25 may be visible through the image forming part 21 of the character/symbol plate 23. This may result that even the unlit image forming part 21 or the unlit segments are reflected and projected to the combiner 8 (i.e., pseudo-lighting phenomenon may occur; see virtual lines z on meter displaying part 15 in FIG. 7). This phenomenon may not occur with other displaying device including no character/symbol plate 23. However, since the combiner 8 of the embodiment is made of a plate having low surface reflectivity, such as a dark plate or semi-translucent dark smoke plate, the reflection of the unlit image forming parts 21 on the combiner 8 are attenuated (i.e., it becomes possible to prevent the unlit image forming parts 21 or the unlit segments from being reflected and projected to the combiner 8). Accordingly, the image shown by the head-up display apparatus 4 becomes clear and easy to see. That is, it becomes possible to eliminate troublesomeness in the reflection of the unlit segment.

When other types of displaying device are applied, it may be necessary to compensate the brightness difference or the contrast between the image 6 and the background by applying surface treatment with an expensive enhanced reflection film so as to increase the surface reflectivity of the combiner 8. However, when the displaying device is configured by the segment display 18 including the light sources 22 and the character/symbol plate 23 together with the combiner 8 having a dark plate or a dark smoke plate, the combiner 8 has a sufficient visibility. Therefore, in this embodiment, the surface treatment on the reflection surface of the combiner 8 with such an expensive enhanced reflection film is not necessary. That is, the manufacturing cost of the head-up display apparatus 4 is reduced by omitting the enhanced reflection film. Further, since the surface treatment with the enhanced reflection film is not applied to the reflection surface of the combiner 8, the surface reflectivity of the combiner 8 is kept low. That is, it can further suppress the occurrence of the pseudo-lighting phenomenon of the image forming parts 21.

Additionally, when a dark plate or a dark smoke plate is used as the combiner 8, depending on attachment conditions of the head-up display apparatus 4, the combiner 8 may partially cover the windshield glass 2 and thereby may disturb the eyesight of the driver. However, as the head-up display apparatus 4 of the embodiment is installed inside the instrument panel 3, the combiner 8 of the embodiment can be disposed at a position where the combiner 8 does not disturb the eyesight of the driver for driving.

(2) The light-housing 25 is disposed between the light sources 22 and the character/symbol plate 23 such that the light emitted from each of the light sources 22 is divided by the light-guiding holes 25a at the light-housing 25 and is individually guided to each of the corresponding image forming parts 21. Accordingly, each of the image forming parts 21 can be brightly illuminated by the light emitted from the light sources 22.

If a small gap is formed between the light sources 22 and the light-housing 25 and/or between the light-housing 25 and the character/symbol plate 23 during assembling, the light leaks from the formed small gap to the adjacent image forming parts 21 and the like. The leaked light then may slightly illuminate some of unlit image forming parts 21, and therefore a phenomenon similar to the above-described pseudo-lighting phenomenon may occur. However, even if such a phenomenon occurs, it is possible to suppress the influence by configuring the combiner 8 with the dark plate or the dark smoke plate having a low surface reflectivity. Additionally, since the surface treatment with the enhanced reflection film is not applied to the reflection surface of the combiner 8, it is possible to further suppress the influence of such light leakage.

(3) The light sources 22 for the segment display 18 may include the white LEDs 22b. With this, the brightness difference or the contrast between the white image 6 generated by the white LEDs 22b and the background of the combiner 8 made of the dark plate or the dark smoke plate becomes large compared to a case where other types of light sources 22 or other color LEDs are used as the light sources 22. Accordingly, it is possible to achieve a head-up display apparatus 4 that can make the image 6 easy to see. Especially, since the white LEDs 22b are used as the light sources 22 together with the dark (black color) combiner 8, the brightness difference between the existing displaying device 5 and the combiner 8 is maximized. Additionally, since the combiner 8 is made of the dark plate or the dark smoke plate, the combiner 8 can absorb ultraviolent radiation emitted by the white LEDs 22b.

(4) Alternatively, the light sources 22 for the segment display 18 may be the RGB full-color LEDs 22c. With this, it is possible to realize a full-color image on the segment display 18.

Additionally, the light sources 22 may be configured by a combination of the RGB full-color LEDs 22c and the white LEDs 22b. With this, it is possible to show various images without using an expensive display panel.

Although the embodiment has been described with reference to the drawings, it should be understood that the embodiment is only an example of the present invention. The present invention should not be limited to the embodiment, and it should be appreciated that variations and modifications may be made in the above embodiment by persons skilled in the art without departing from the gist of the present invention. Further, when the embodiment includes a plurality of elements, any possible combinations of these elements may be possible even without a detailed description. Furthermore, when several embodiments are described in the present invention, any possible combinations of these configurations that may even across these embodiments may be possible even without a detailed description. When applicable, any elements illustrated in the drawings may be included in the scope of the invention even without a detailed description. Additionally, when the term “and the like”, is used, it means it covers similar elements. Further, when the terms “substantially”, “about”, “around”, etc. are used, it should be considered that they cover ranges and/or accuracy within a technical common sense understood by persons skilled in the art.

### REFERENCE SIGNS LIST

1 Vehicle Cabin, 2 Windshield Glass, 3 Instrument Panel, 4 Head-Up Displaying Apparatus, 5 Displaying Device, 7 Opening, 8 Combiner (Dark Plate, Dark Smoke Plate), 18 Segment Display, 21 Image Forming Part, 22 Light Source (LED), 22b White LED, 22c RGB Full-Color LED, 23 Character/Symbol Plate, 25 Light-Housing

### CROSS-REFERENCE TO RELATED APPLICATION

The present application is based on and claims priority to Japanese Patent Application No. 2015-008298, filed on Jan. 20, 2015 with Japan Patent Office, the disclosure of which is hereby incorporated by reference in its entirety.

1. A head-up display apparatus comprising:
a displaying device that is installed inside an instrument panel, the instrument panel being provided under a windshield glass;
an opening portion that is formed in the instrument panel; and
a combiner that is disposed above the opening portion in a exposed state, wherein:
an image of the displaying device is configured to be projected to the combiner through the opening portion,
the combiner is configured to form an image by directly reflecting the image on the displaying device,
the displaying device comprises a segment display, the segment display configured to form a plurality of the images by turning ON and OFF a plurality of image forming parts,
the segment display comprises a plurality of light sources and a character/symbol plate, the character/symbol plate including the plurality of image forming parts, and the image forming parts being configured such that light emitted from the plurality of the light sources pass through the plurality of image forming parts, and
the combiner is made of a non-translucent dark plate or a semi-translucent dark smoke plate, and
the combiner has a surface reflectivity that can suppress a reflection of the image forming parts when the image forming parts are turned OFF.

2. The apparatus according to claim 1, further comprising:
a light-housing that is disposed between the light sources and the character/symbol plate,
wherein the light-housing is configured to guide the light emitted from each of the plurality of the light sources to each of the corresponding image forming parts.

3. The apparatus according to claim 1, wherein the light sources include white LEDs.

4. The apparatus according to claim 1, wherein the light sources include RGB full-color LEDs.

5. The apparatus according to claim 3, wherein the light sources include RGB full-color LEDs.

6. The apparatus according to claim 1, wherein the combiner is not applied with a half-mirror treatment.

7. The apparatus according to claim 1, wherein the combiner is not applied with an enhanced reflection film. n
